(19) United States
(12) Patent Application Publication
(10) Pub. No.: US 2011/0121600 A1
(43) Pub. Date: May 26, 2011

(54) CIRCUIT FOR THE ELECTRICAL ACTUATION OF THE TWO-PART TAILGATE FOR MOTOR VEHICLES

(76) Inventors: Radek Cimrman, Bakov nad Jizerou (CZ); Miroslav Topek, Pardubice (CZ)

(21) Appl. No.: 12/524,399

(22) PCT Filed: Jan. 28, 2008
(86) PCT No.: PCT/CZ2008/000010

§ 371 Date: Sep. 18, 2009

(30) Foreign Application Priority Data
Jan. 31, 2007 (CZ) PV 2007-83

(51) Int. Cl. B62D 33/037

(52) U.S. Cl. 296/56

(57) ABSTRACT

The two-part tailgate for motor vehicles, which is made of the top part and the bottom part, is controlled by the controller, which actuates the actuating elements, the lower lock, and the tightener based on signals sent from the unlocking switch and the switch of the top part. The actuating elements are disposed in the trunk of the chassis, and comprise the motor, and the large gear wheel driven by the motor via the transmission, wherein the two final positions are signaled by the control switch of the bottom part and the control switch of the tailgate.

### TECHNICAL FIELD

The invention relates to the circuit for the electrical actuation of the two-part tailgate for motor vehicles. The electrical actuation according to the presented invention serves to open only the lower part of the tailgate or the entire tailgate.

### PREVIOUS PRIOR ART

According to the prior art, a design of the tailgate in two parts is known, and therefore either the entire tailgate, as in the case of liftback vehicle bodies, or only the lower part, as in the case of hatchback vehicle bodies, can be opened.

Several structural variants of such two-part tailgates are known. The most common include the tailgate for motor vehicles which comprises an upper and lower part. The two-part tailgate is provided with an upper lock which serves to connect the upper part and lower part and/or the upper part of the tailgate to the vehicle body, and with a lower lock which ensures the connection of the tailgate and/or of the lower part to the vehicle body.

A solution for the electrical actuation for opening such two-part tailgates is not known.

### ESSENCE OF THE INVENTION

The solution for the electrical actuation for opening the two-part tailgate is provided in the presented invention.

The two-part tailgate for vehicles, which tailgate comprises the upper part and the lower part, is actuated by a controller which activates the actuating elements, the lower lock and the attracting means on the basis of signals from the unlocking switch and from the switch of the upper part, with these two switches being arranged on the lower part of the tailgate. The actuating elements are mounted in the trunk space of the vehicle body and comprise the motor, which is driven by means of the gear mechanism, the large gear wheel, with the two end positions being indicated by the control switch of the lower part and the control switch of the tailgate.

### OVERVIEW OF THE FIGURES IN THE DRAWING

The invention will be explained in greater detail with reference to the schematic drawings below.

FIG. 1 illustrates the tailgate in the closed position.

FIG. 2 illustrates the tailgate with only the lower part open, and

FIG. 3 illustrates the tailgate when it is entirely open.

FIG. 4 shows a schematic illustration of the circuit for the electrical actuation of the two-part tailgate for motor vehicles.

FIG. 5 shows a schematic illustration of the electrical circuit of the actuating element.

FIG. 6 shows a sectional drawing of the actuating element.

### EXEMPLARY EMBODIMENTS OF THE INVENTION

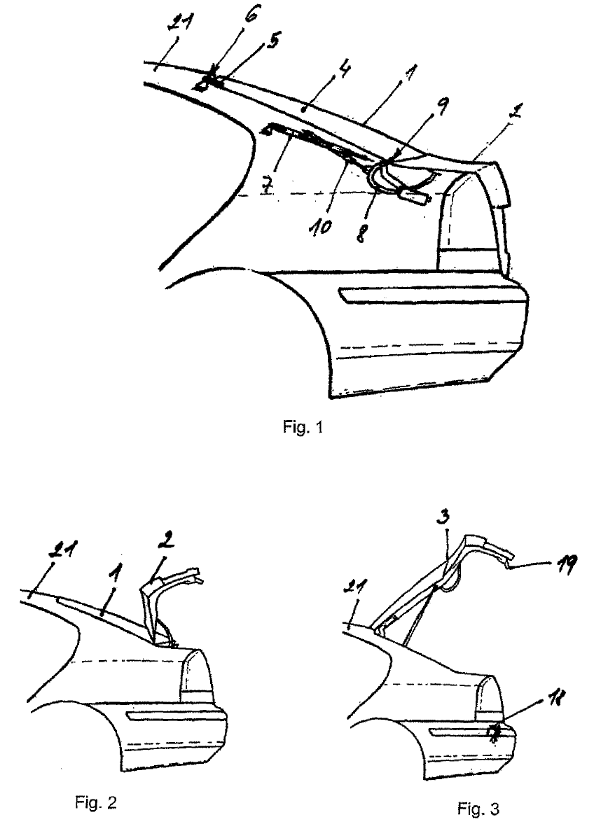

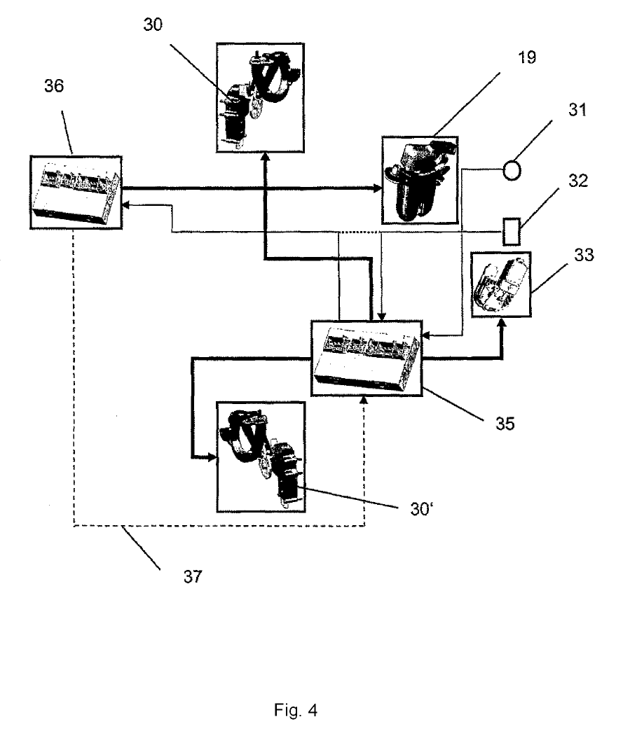

The two-part tailgate 3 for motor vehicles according to FIGS. 1 to 3 comprises the upper part 1 and the lower part 2. At the lower edge, the lower part 2 is provided with the lower lock 19 for receiving the eye 18 which is mounted on the lower beam of the trunk space of the vehicle body (21). The upper part 1 is provided with a glass pane 4 and is fixed to the vehicle body 21 by means of the first pair of single-axis mounting assemblies 5 such that it can swing open about the axis 6. The first pair of pneumatic springs 7 is arranged between the vehicle body 21 and the upper part 1. The lower part 2 is fixed to the lower edge of the upper part 1 by means of the second pair of single-axis mounting assemblies 8 such that it can swing open about the axis 9. The second pair of pneumatic springs 10 is arranged between the upper part 1 and the lower part 2.

FIG. 4 shows the circuit for the electrical actuation of the tailgate for motor vehicles. The lower part 2 of the two-part tailgate 3 is provided with the unlocking switch 32 which actuates the lower lock 19 which ensures the connection of the lower part 2 and the tailgate 3 to the vehicle body 21. In the starting position, only the lower part 2 can be opened by the switch 32, that is to say that the upper part 1 and the vehicle body 21 are firmly connected to one another. Furthermore, the switch 31 for the upper part, which switch serves to actuate the actuating elements 30, 30′ which are mounted in the trunk space of the vehicle body 21, is located on the lower part 2. In order to open the entire tailgate 3, it is first necessary to switch the switch 31, as a result of which the upper part 1 and the lower part 2 are firmly connected to one another with the aid of the actuating elements 30, 30′, with the connection of the upper part 1 to the vehicle body 21 being released at the same time, and the switch 32 is then activated, as a result of which the lock 19 is released from the eye 18. The tailgate 3 can then be opened with the aid of a handle which is often profile-extruded in the lower part 2. After the tailgate is closed again, the actuating elements reassume the starting position, that is to say only the lower part 2 can be opened by the switch 32. If the vehicle is locked, actuation is prevented and neither the lower part 2 nor the entire tailgate 3 can be opened.

Electrical actuation of the tailgate for motor vehicles is ensured by the controller 35 of the tailgate which receives signals from the unlocking switch 32 and the switch 31 for the upper part and from the controller 36 for the comfort and convenience electronics, and activates the actuating elements 30, 30′ and, by means of the controller 36, the lower lock 19 as a function of the state of the signals.

In an expedient embodiment, electrical actuation is controlled by a single controller which receives signals from the unlocking switch 32 and the switch 31 for the upper part and activates the actuating elements 30, 30′ and the lower lock 19 as a function of the state of the signals. Furthermore, the attracting means, which helps to overcome the resistance of the sealing of the vehicle body along the perimeter of the tailgate 3 and as a result facilitates closing, is activated by the controller when the tailgate 3 or the lower part 2 is closed.

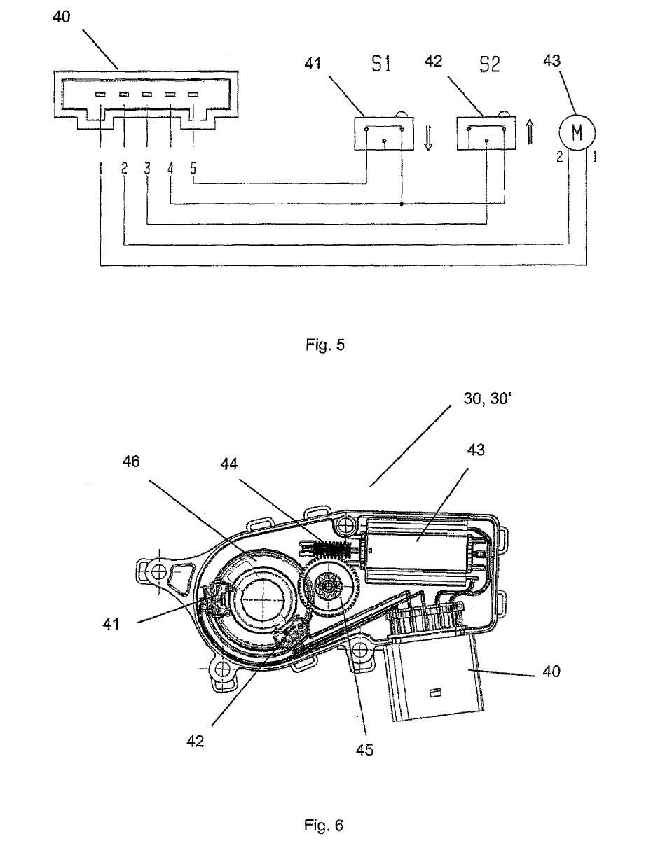

FIGS. 5 and 6 show that the actuating elements 30, 30′ comprise the motor 43, the gear mechanism, which comprises the worm shaft 44 on the rotor of the motor 43 and the small gear wheel 45, and the rotatable gear wheel 46. The two end positions are indicated by the control switch 41 for the lower part and the control switch 42 for the tailgate. The actuating elements 30, 30′ are mounted in the trunk space of the vehicle body 21 and actuate the locks, with which the tailgate 3 is provided and which ensure the connection of the upper part 1 to the vehicle body 21 when only the lower part 2 is opened, or ensure the connection of the upper part 1 to the lower part 2 when the entire tailgate 3 is opened.

The switches 41 and 42 switch and/or open as a function of the position of the gear wheel 46 which is operated by the motor 43, with the motor being driven as a function of the signal from the controller. When one of the two end positions is reached, the motor 43 remains at a standstill.

### LIST OF REFERENCE SYMBOLS

1 Upper part
2 Lower part
3 Tailgate
4 Glass pane
5 First single-axis mounting assembly
6 Axis of the first mounting assembly
7 First pneumatic compression spring
8 Second single-axis mounting means
9 Axis of the second mounting means
10 Second pneumatic compression spring
18 Eye
19 Lower (door) lock
21 Vehicle body
30, 30′ Actuating elements
31 Switch for the upper part
32 Unlocking switch
33 Pull means
35 Controller for the tailgate
36 Controller for the comfort electronics
37 Busbar
40 Plug
41 Control switch for the lower part
42 Control switch for the tailgate
43 Motor
44 Worm shaft
45 Small gearwheel
46 Output gear wheel

1. A circuit for the electrical actuation of the two-part tailgate for motor vehicles, which tailgate comprises the upper part and the lower part, wherein the lower part is provided with an unlocking switch for actuating the lower lock, with the lock ensuring the connection and disconnection of the tailgate and/or of the lower part to/from the vehicle body, and also with a switch for the upper part, which switch serves to actuate the actuating elements which are mounted in the trunk space of the vehicle body.

2. The circuit for the electrical actuation of the two-part tailgate for motor vehicles as claimed in claim 1, wherein the actuating elements ensure the connection and disconnection of the upper part and of the lower part and/or of the upper part to/from the vehicle body.

3. The circuit for the electrical actuation of the two-part tailgate for motor vehicles as claimed in claim 1, wherein the electrical actuation of the two-part tailgate for motor vehicles is controlled by the controller of the tailgate, said controller receiving signals from the unlocking switch and the switch for the upper part and from the controller of the comfort and convenience electronics, and activating the actuating elements and, by means of the controller, the lower lock as a function of the state of these signals.

4. The circuit for electrical actuation of the two-part tailgate for motor vehicles as claimed in claim 1, wherein the electrical actuation is controlled by the controller which receives signals from the unlocking switch and the switch for the upper part, and actuates the actuating elements and the lower lock as a function of the state of these signals and the state of the central locking system.

5. The circuit for the electrical actuation of the two-part tailgate for motor vehicles as claimed in claim 1, wherein the actuating elements comprise the motor which is driven via the gear mechanism, the large gear wheel, with the two end positions being indicated by the control switch for the lower part and by the control switch for the tailgate.

6. The circuit for the electrical actuation of the two-part tailgate for motor vehicles as claimed in claim 5, wherein the gear mechanism comprises the worm shaft, with which the rotor of the motor is provided, and a small gear wheel.

7. The circuit for the electrical actuation of the two-part tailgate for motor vehicles as claimed in claim 5, wherein the switches and close and open as a function of the position of the gear wheel which is driven by the motor, with the motor being controlled as a function of signals from the controller.
